(19) United States
(12) Patent Application Publication
(10) Pub. No.: US 2007/0212504 A1
(43) Pub. Date: Sep. 13, 2007

(54) BONDING COMPOSITION WITH COHESIVE FAILURE

(75) Inventor: Jean-Claude ENGELAERE, Coudekerke-Branche (FR)

Correspondence Address: KENYON & KENYON LLP, ONE BROADWAY, NEW YORK, NY, 10004, US

(73) Assignee: SOPLARIL, Rueil Malmaison (FR)

(21) Appl. No.: 11/748,146

(22) Filed: May 14, 2007

Related U.S. Application Data
(63) Continuation of application No. 11/486,391, filed on Jul. 12, 2006.
Application No. 11/486,391 is a continuation of application No. 10/416,971, filed on Nov. 19, 2003, now abandoned.

(30) Foreign Application Priority Data
Nov. 17, 2000 (FR) 0014854

(51) Int. Cl. B32B 23/08; B29C 47/12; B32B 7/08; B65D 77/10

(52) U.S. Cl. 428/35.7; 156/242; 220/276; 264/177.1; 428/221; 428/475.2; 428/500

(57) ABSTRACT

The invention concerns a novel bonding composition comprising at least a hot-melt and at least a binder. Said composition is useful in multilayer structures, and in packages.

The subject of the invention is a novel bonding composition, its method of preparation and its use in packages having a peelable/repositionable structure.

Various peelable structures used in resealable packages are known. These structures generally comprise a container, (for example a tray) to which a cover is welded. This cover comprises a welding layer (generally made of polyethylene), a permanent adhesive layer (generally a hot melt) and an upper layer (generally made of PET, PA, OPA, OPP, etc., generally forming a barrier), optionally with a binder layer or tie layer between these layers (3 layers or 5 layers). This cover is welded, along a seam on the tray, to a corresponding welding layer, generally made of the same material. In the seam region, there is welding between the two PE welding layers. When a user pulls on the cover, this tears in the seam region, but by baring the adhesive, since the PE of the welding layers is fastened during welding. The user can then reseal the cover since the adhesive can come into contact with the upper layer and fulfill its “bonding” role. During tearing, the adhesive may be found on only one of the exposed faces, or on both faces. Such an adhesive is conventionally a hot melt, applied hot (by (co)extrusion, lamination, etc.). It is also possible to place this adhesive in the tray, and no longer in the cover.

Such structures are described, for example, in the following patent applications and patents:

WO-A-9719867; U.S. Pat. No. 4,673,601; FR-A-2 669 607;

EP-A-0 661 154; WO-A-9308 982; U.S. Pat. No. 5,061,532; U.S. Pat. No. 3,335,939;

U.S. Pat. No. 5,089,320; U.S. Pat. No. 4,913,307; U.S. Pat. No. 5,382,472; U.S. Pat. No. 5,145,737;

GB-A-1 536 428; GB-A-1 461 698; U.S. Pat. No. 4,280,653; U.S. Pat. No. 4,381,848;

U.S. Pat. No. 4,438,850; EP-A-0 554 152; U.S. Pat. No. 4,693,390; U.S. Pat. No. 4,801,041;

U.S. Pat. No. 4,858,780; U.S. Pat. No. 3,946,872; U.S. Pat. No. 5,686,127; U.S. Pat. No. 5,316,603;

U.S. Pat. No. 5,178,293; U.S. Pat. No. 3,454,210; WO-A-9640504; GB-A-2 319 746;

WO-A-9 640 504; EP-A-0 403 393; EP-A-0 306 982; US-A-5,747,127; and EP-A-1 006 056.

Although these packages are now very common, it is desirable, however, to optimize their properties during the opening process. It will be desirable for the hot melt to tear so as to undergo cohesive failure, so that the hot melt is present on both sides to be rebonded.

In fact, it is desirable for the hot melt to allow the following properties to be obtained:

very good adhesion between the hot melt and the PE or binder layers, depending on the case (3 layers or 5 layers);

low cohesion of the hot melt layer, in order to make it easier to tear it;

when opening the package, cohesive failure within the hot melt, and preferably only in the weld zone;

calibrated opening force and reseal strength;

high transparency of the layers without a change in appearance, even after thermoforming; and

good thermoformability of the structure, without delamination between the layers

Very good adhesion between the hot melt and the PE or binder layers is desirable, as otherwise delamination would occur during opening and thus the hot melt would only be on one face of the opening region.

It is also desirable for there to be low cohesion of the hot melt layer, since the excessively high cohesion would then be greater than the strength of adhesion of the hot melt to the PE or to the binder, which would also result in delamination.

If both the adhesion and cohesion of the hot melt are high, there is a risk of it being impossible or excessively difficult to open the package.

Transparency is desirable, so as to allow the consumer to make an appraisal of the contents of the package.

Thermoformability is desirable, as this allows standard machines to be used.

However, at the present time, hot melts have relatively high cohesive strengths.

It has been proposed to “dope” the hot melt with fillers or processing aids in order to reduce the cohesive strength and/or to make it easier to tear it. On the other hand, there is then a reduction in the reseal strength of the package (since the rebonding area is smaller, insofar as the added fillers do not exhibit tack). In addition, incorporation of such fillers impairs the final transparency of the product.

It is also possible to vary the two major components of the hot melt, namely the thermoplastic elastomer and the tackifying resin, especially their relative proportions. Although adding a larger amount of tackifying resin reduces the cohesion, the adhesion of the hot melt to the PE or the binder is affected thereby. In addition, the use of excessively large amounts of resin causes the melt viscosity of the hot melt to drop, making it very difficult to extrude or coextrude.

The invention aims to solve the abovementioned problems, by adding to the conventional hot melt a quantity of a suitable binder or of a non-elastomeric polymer of the EVA resin or metallocene PE type.

The invention therefore provides a novel bonding composition comprising at least one hot melt and at least one binder.

The invention, and also its variants, will now be described in greater detail in the description that follows.

The hot melt used in the invention is conventional, especially one based on an elastomer or on other polymers that are not elastomeric, such as EVA. It is also possible for this hot melt not to be converted into the melt state ((co)extrusion), but to be diluted in a solvent medium or an aqueous phase.

Very generally, and nonlimitingly, the hot melt adhesives comprise:

a) polymers such as EVA, PE, PP, EEA (ethylene/ethyl acrylate) and thermoplastic elastomers or rubbers (styrene (block) copolymers of the styrene-butadiene, styrene-isoprene or styrene-ethylene-butadiene type, or butadiene-based polymers such as NBR, or ethylene-propylene copolymers such as EPR). Their content in the formulation is from 5 to 50% and their function is to provide adhesion (polarity), barrier properties, gloss, mechanical strength, flexibility and viscosity control;

b) tackifying resins, which may be aliphatic or aromatic, oil-derived or natural resins (rosin esters, terpenes or terpene phenolics). Their content in the formulation is from 0 to 45%. They increase the hot tack and adhesion, and regulate the cohesion;

c) paraffin and other waxes, which may have a content in the formulation of 20 to 80%. They play a role as regards the barrier properties, gloss, stiffness, cost, drop point and hardness of the hot melt;

d) plasticizers, which may have a content in the formulation of between 0 and 10%. They increase the cold tack and regulate the flexibility and viscosity of the hot melt;

e) antioxidants, which have a content of 0.2 to 10% in the formulation. They stabilize the components when hot and when cold; and

f) fillers, which are added to the formulation when it is desired to have particular properties, such as UV (oxidation) resistance, fire retardancy, anti-allergy properties, rheology, etc.

It is preferable to use a pressure-sensitive hot melt consisting of an elastomer/tackifying resin compound. The pressure-sensitive adhesive consists of a compound of:

40 to 80% thermoplastic elastomer;

20 to 60% tackifying resin; and

<30% other constituents: plasticizing oil, antioxidant, additives, etc.

An example of such a hot melt adhesive is M3062 from Ato Findley (melt flow index of 5.3 g/10 min at 190° C./2.16 kg).

The binder used in the invention is conventional. It corresponds to what a person skilled in the art understands as a polymer material for joining two layers of polymers together, especially when these polymers are mutually incompatible.

As examples, mention may be made of (co)polyolefins optionally modified by an unsaturated carboxylic acid derivative (the modification being effected by copolymerization, terpolymerization or grafting). Examples of such binders are given, without being limited thereby, in the following patents: EP-A-210 307, EP-A-33 220, EP-26 6994, FR-A-2 132 780, EP-A-171 777, U.S. Pat. No. 4,758,477, U.S. Pat. No. 4,762,890, U.S. Pat. No. 4,966,810, U.S. Pat. No. 4,452,942, and U.S. Pat. No. 3,658,948.

Examples of such binders are:

ethylene or propylene homopolymers, functionalized as below;

metallocene polyethylene, pure or as a blend;

ethylene copolymers, the ethylene being copolymerized with propylene, butene, hexene or octene, blends optionally with ethylene-propylene copolymers, grafted with maleic anhydride, said ethylene/alpha-olefin copolymers containing, for example, 35 to 80% by weight ethylene, the degree of anhydride grafting being between 0.01 and 1%, for example between 0.05 and 0.5%, by weight with respect to the total weight of copolymer;

ethylene/vinyl acetate copolymers (EVA), which may or may not be maleated (it being possible for the maleic anhydride to be grafted or terpolymerized), containing more particularly up to 40% by weight of vinyl acetate and optionally from 0.01 to 1% by weight of grafted maleic anhydride or from 0.1 to 10% by weight of terpolymerized maleic anhydride, in relation to the total weight of copolymer, this copolymer being denoted by the term EVA resin;

ethylene/alkyl (meth)acrylate (such as methyl acrylate, ethyl acrylate or t-butyl acrylate)/maleic anhydride copolymers, containing up to 40% by weight of alkyl (meth)acrylate and from 0.01 to 10% by weight of maleic anhydride, in relation to the total weight of copolymer;

the above polymers in which the anhydride is replaced completely or partly with glycidyl methacrylate;

the above polymers diluted with a polyolefin (of the type of those before functionalization) or an elastomer, such as EPR or EPDM; and

blends thereof.

The preferred binders are those based on EVA, particularly grafted with maleic anhydride, and those based on metallocene PE.

According to one embodiment, the binder comprises a tackifying resin of the same type (which may or may not be identical) as that used in the hot melt. The amounts can vary, for example up to 40% by weight. This variant is useful when the binder does not initially contain a tackifying resin since, in this case, the addition of such a binder reduces the final tackifying resin content in the end product. Tackifying resin is then added to the binder in order to obtain a tackifying resin content in the end product which is substantially identical to the content in the starting hot melt.

The hot melt/binder pair may be readily determined by a person skilled in the art, according to the respective compositions. Thus, for a hot melt based on SIS or SBS block copolymers, an EVA-based binder is very appropriate. In fact, EVA-based binders are generally compatible with most hot melts.

According to an alternative embodiment of the invention, another resin, for example of the EVA type, is added directly to the hot melt. In this case, it may be considered that the constituent polymer of the hot melt comprises a nonelastomeric polymer and an elastomeric polymer (the invention therefore also covers a two-polymer hot melt based on elastomeric and nonelastomeric polymers). For example, the two-polymer hot melt according to the invention comprises at least one nonelastomeric polymer, chosen from EVA, PE, PP and EEA, and at least one elastomeric polymer, chosen from thermoplastic elastomers or rubbers, of the styrene block copolymer type, butadiene-based polymers, such as NBR, or ethylene-propylene copolymers, such as EPR. The elastomer/nonelastomer weight ratio may vary widely, for example from 100/0 (0 being excluded) to 50/50, preferably 95/5 to 80/20. If a nonelastomeric resin is added to the hot melt, the above proportions are recalculated in order to take account of all the resins added.

In particular, the invention covers two other embodiments, one in which the binder is added to the hot melt layer (“hot melt/binder”) and one in which the hot melt is added to the binder layer (“binder/hot melt”) (the two embodiments may occur together, although this is not preferred).

In the first case (“hot melt/binder”), the composition preferably comprises, by weight, from 20 to 99% of at least one hot melt and 80 to 1% of at least one binder, and advantageously from 60 to 90% hot melt and 40 to 10% binder.

In the second case (“binder/hot melt”), the composition preferably comprises, by weight, from 20 to 99% of at least one binder and 80 to 1% of at least one hot melt, and advantageously from 60 to 90% binder and 40 to 10% hot melt.

Especially in the case of the EVA resin, it is also possible, by varying the vinyl acetate content, to modify the somewhat elastomeric nature of said resin.

The compositions according to the invention have, for example, a viscosity of between 500 000 cPs and 1 000 000 cPs at 150° C.

The conditions of manufacture of the compounds are conventional; they correspond either to melt blending, or in granule form the blending then taking place in an extruder.

These compositions according to the invention are used in conventional structures, namely 5-layer or 3-layer structures (with and without a binder):

multilayer structure comprising:
(a) a polyethylene layer;
(b) a layer of a composition according to the invention (hot melt/binder or two-polymer hot melt based on elastomeric and nonelastomeric polymers); and
(c) a layer of polymer, preferably PE;

multilayer structure comprising:
(a) a polyethylene layer;
(b) a binder layer;
(c) a layer of a composition according to the invention (hot melt/binder);
(d) a binder layer; and
(e) a layer of polymer, preferably PE;

it being possible for the binders of layers (b) and (d) and those contained in the compositions (c) to be identical or different, preferably all based on the same resin;

multi layer structure comprising:
(a) a polyethylene layer;
(b) a layer of a composition according to the invention (binder/hot melt);
(c) a hot melt layer;
(d) a layer of a composition according to the invention (binder/hot melt); and
(e) a layer of polymer, preferably PE;

it being possible for the hot melts of layers (b) and (d) and those contained in compositions (c) to be identical or different, preferably identical.

The latter structure is especially suitable in the case of hot melts having a relatively low cohesive strength. This is because the addition to the binder layer improves the interfacial adhesion, which makes it easier for the tear force to propagate into the hot melt. In this case, the opening and propagation forces depend directly on the adhesive strength of the hot melt. According to this embodiment, the thickness of the hot melt layer may be increased.

In the above structures, the binder is preferably an EVA, optionally grafted with maleic anhydride, or a metallocene PE;

multilayer structure comprising:
(a) a polyethylene layer;
(b) a binder layer, the binder preferably being based on EVA and/or on metallocene PE;
(c) a layer of a composition according to the invention (two-polymer hot melt based on elastomeric and nonelastomeric polymers);
(d) a binder layer, preferably one based on EVA and/or metallocene PE; and
(e) a layer of polymer, preferably PE.

The EVA may also be grafted with maleic anhydride.

These structures are obtained using conventional techniques.

The structure may be prepared using several processes. These processes comprise flat cast (co)extrusion, bubble (co)extrusion, etc.

It should be noted that these structures according to the invention may apply to any type of resealable package according to the prior art. Thus, it is possible to use the structures as an integral part of the container or of the cover, or as a film that can be welded onto the latter in the case of bagmaking, as all or part of packages such as bags, doypacks, FFH or FFV package products, covers, trays, whether thermoformed or not. Thus, these structures according to the invention may especially apply to the packages forming the subject matter of the following patent applications:

WO-A-9719867; U.S. Pat. No. 4,673,601; FR-A-2 669 607; EP-A-0 661 154; WO-A-9308982; U.S. Pat. No. 5,061,532; U.S. Pat. No. 3,335,939; U.S. Pat. No. 5,089,320; U.S. Pat. No. 4,913,307; U.S. Pat. No. 5,382,472; U.S. Pat. No. 5,145,737; GB-A-1 536 428; GB-A-1 461 698; U.S. Pat. No. 4,280,653; U.S. Pat. No. 4,381,848; U.S. Pat. No. 4,438,850; EP-A-0 554 152; U.S. Pat. No. 4,693,390; U.S. Pat. No. 4,801,041; U.S. Pat. No. 4,858,780; U.S. Pat. No. 3,946,872; U.S. Pat. No. 5,686,127; U.S. Pat. No. 5,316,603; U.S. Pat. No. 5,178,293; U.S. Pat. No. 3,454,210; WO-A-9640504; GB-A-2 319 746; WO-A-9 640 504;

EP-A-0 403 393; EP-A-0 306 982; U.S. Pat. No. 5,747,127; and EP-A-1 006 056.

Thus, the invention will apply especially (but not limitingly) to a package provided with an opening having a sheet welded along the edge of the opening, this sheet consisting of at least three layers, namely an applied welding layer welded along a seam to the edge of the opening, a barrier-forming outer layer, and an adhesive interlayer made of the composition according to the invention, the weld seam of the welding layer along the edge of the opening having a tear strength greater than the strength of adhesion between the welding layer and the adhesive layer so that, during the first operation of releasing the opening, the weld seam remains in place along the edge of the opening and separates from the rest of the welding layer and from the adhesive layer, which is thus exposed over a certain area and makes it possible, by reapplication against the seam, to close the container again (the adhesive may be present on only one face, but preferably on both faces, as a result of cohesive failure).

The structure according to the invention may also apply to doypacks (stand-up pouches, for example eco-refills for detergents) in order to make it easier for them to be opened and resealed easily. This avoids having to add a ZIP® strip which is expensive and difficult to deposit during its manufacture (risk of leaks). This structure may also serve for a covering of injection-molded pots and trays. It can also be used as a welding agent in structures intended for packaging on a horizontal machine of the FFH type (for example for long-life bread, slabs of cheese).

Thus, the invention provides a resealable package comprising a structure according to the invention as described above.

According to a first embodiment, the resealable package comprises:

(A) a container, said container comprising a support layer, a complexable layer, a layer of a composition according to the invention as described above and a tearable welding layer; and, facing it

(B) a cover, said cover comprising a second welding layer and a second support layer;

said welding layers being welded along a seam.

According to a second embodiment, the resealable package comprises:

(A) a container, said container comprising a support layer, a structure according to the invention as described above, this structure being attached to the support layer (this structure including, as above, a welding layer, generally made of PE); and, facing it

(B) a cover, said cover comprising a second welding layer and a second support layer;

said welding layers being welded along a seam.

The invention also provides the above packages, in which the cover and container are reversed, or identical.

According to a third embodiment, the resealable package comprises:

(A) a cover, said cover comprising a support layer, a complexable layer, a layer of a composition according to the invention as described above and a tearable welding layer; and, facing it

(B) a container, said container comprising a second welding layer and a second support layer,

said welding layers being welded along a seam

According to a fourth embodiment, the resealable package comprises:

(A) a cover, said cover comprising a support layer, a structure according to the invention as described above, this structure being attached to the support layer (this structure including, as above, a welding layer, generally made of PE); and, facing it

(B) a container, said container comprising a second welding layer and a second support layer,

said welding layers being welded along a seam.

According to a fifth variant, the resealable package comprises:

(A) a first film, said first film comprising a support layer, a complexable layer, a layer of a composition according to the invention as described above and a tearable welding layer; and, facing it

(B) a second film, said second film being identical to the first film;

said welding layers being welded along a seam.

According to a sixth variant, the resealable package comprises:

(A) a first film, said first film comprising a support layer, a structure according to the invention as described above, this structure being attached to the support layer (this structure including, as above, a welding layer, generally made of PE); and, facing it

(B) a second film, said second film being identical to the first film;

said welding layers being welded along a seam.

A layer of adhesive, for example polyurethane, may be present, if necessary, for example between support layer/complexable layer, second support layer/second welding layer, etc.

These structures are used in particular in the lower tray of the package; according to this embodiment, they are preferably attached to a support, such as PET or PVC.

This support film gives the mechanical properties and barrier properties with respect to gases, water vapor and aromas. As support-forming film, it is possible to use polyolefins (cast PP, oriented PP, PE), polamides (cast PA, copolyamide, uniaxially or biaxially oriented PA), styrenics (crystal PS, impact PS, oriented PS), PVC, coated or uncoated papers, polyesters (cast PET, oriented PET, crystallizable PET, G-PET), aluminum, coated films (coated with PVDC, PVA, etc.) and vacuum-metalized films (based on aluminum, alumina, SiOₓ, etc.).

The structure according to the invention is preferably attached to the support. According to this embodiment, the structure is prepared, especially by coextrusion, and then this structure is applied to the support using various methods. This structure may, for example, be attached by lamination, by extrusion-lamination, by hot calendering or by extrusion-coating, depending on the case; the complexible layer receives an additional bonding layer.

In the first two methods above, a binder layer is present between the structure according to the invention and the support, and it bonds them together.

In the case of lamination, the structure is prepared and then attached to the support, for example cold (that is to say at a temperature below the melting point of the films in question). The bonding layer may be an adhesive, especially a polyurethane adhesive, in particular of the polyether or polyester type, which may or may not be diluted in a solvent. A corona treatment of the complexable layer is preferred.

In the case of extrusion-lamination, the structure is prepared, especially by coextrusion, and then attached to the support (preferably cold), a binder layer being placed between the structure and the support, preferably by extrusion. This binder layer may be a coextrusion binder, as described above. This binder will preferably have a melting point lower than the support layer. Extrusion-lamination is similar to lamination, the difference being the binder layer instead of the adhesive layer. A corona treatment of the complexable layer is possible, but this is optional.

In the case of hot calendering, the structure is prepared, especially by coextrusion, and then applied directly to the support by means of calenders, which heat the films prepared beforehand. Since the contacting layers are hot, there will be adhesion between them. In this case, it is unnecessary for there to be an additional bonding layer (although this is possible), the complexable layer being sufficient to bond them together. This complexable layer may, for example, be a layer of EVA having a high VA content. A corona treatment is unnecessary, this may in fact be unadvisable.

In the case of extrusion-coating, the still hot coextruded structure (optionally with an additional binder layer) is applied, while still hot, directly to the support (for example a PET film).

The complexable layer of the structure is preferably corona treated, especially so as to obtain a surface tension of 38 to 44 dynes (i.e. 38 to 44 mN/m).

It is preferable for the assembly formed by all the layers of the structure, the binder layer and the support not to be coextruded together, unlike the prior art.

Once the structure has been attached to the support, this combination is preferably thermoformed.

The final package is obtained by welding the container (the tray) to the cover, or by welding the film to itself in the case of bagmaking.

This package comprises a container (A) and a cover (B). The container (A) comprises a support layer (1), a complexable layer (2) (and generally adhesive layer between these two layers), a binder layer based on the composition according to the invention (3) and a tearable welding layer (4). If necessary, the container may also include, between the support layer (1) and the complexable layer (2), a bonding layer (7). An under-part of this container (A) is the structure according to the invention, which comprises the layers (2), (3) and (4). The cover (B) comprises a support layer (6) and a welding layer (5). The tearable welding layer (4) and the welding layer (5) face each other. If necessary, the cover (B) may also include a bonding layer (8) between the layers (5) and (6). The cover (B) is welded to the container (A), for example by stamping, using bars, only one of which is preferably heated and placed cover side. In the weld zone, namely the seam (D), the container and the cover undergo deformation. This deformation is characterized by a reduction and/or modification in the thicknesses, due to the softening and/or melting of certain layers, which results in the flow of their components along the edges of the weld seam. The weld zone (seam (D)) defines the region of weakness. The support layer (6) of the cover (B) is generally little affected by the welding, since the components of this support layer have melting points generally well above those of the components of the welding layer (5). The same applies in general to the binder layer (8) of the cover. The above remarks apply in the same way to the support layer (1) and to the bonding layer (7) of the container (A), which in addition are further away from the heat source, for the preferred case in which only a single heating bar is used on the side facing the cover.

The welding conditions (time, temperature, pressure) are conventionally adjusted so that the deformation takes place at the tearable welding layer (4) and welding layer (5). Since the layer (3) based on the composition according to the invention is generally malleable, because of its nature, and generally represents a relatively large thickness of the structure, there will in general be no melting or flow throughout the entire thickness. Since the layer based on the composition according to the invention withstands substantially the entire deformation, the complexable layer (2) will therefore, in general, not be deformed and therefore not weakened. The weakening, in the weld seam, is therefore mainly generated in the tearable welding layer (4) and possibly partly in the layer (3) based on the composition according to the invention. The welding layer (5) is not weak and its tear strength is greater than that of the layer (4) and greater than the cohesive strength of the layer (3) based on the composition according to the invention. When opening the package, the stresses propagate and cause the weakest layers to fail, namely the tearable welding layer (4) and part of the thickness of the layer based on the composition according to the invention.

The tearing occurs on each side of the weld seam (D) (stamped region), which has the effect of releasing a strip composed of the torn tearable welding layer (9) and of a part (10) of the layer (3) based on the composition according to the invention, which remain welded to the welding layer of the cover (B). Part of the layer (3) based on the composition according to the invention, which ensures resealing, is on each of the internal faces of the container (A) and cover (B) of the package. To reseal the package, all that is required is to reposition, face to face, the two regions corresponding to the tearing and to exert pressure. The reseal strength (rebonding of the adhesive to itself) is proportional to the pressure exerted for resealing. In general, the tearing in the adhesive layer based on the composition according to the invention results in a slight whitening of the latter, because of the irregularity of the fracture surfaces, resulting in iridescence. The reseal is then of maximum strength when the pressure exerted makes the tear region transparent again. This is because, in this case, continuity of the adhesive layer has been reestablished and this adhesive layer then no longer exhibits surface iridescence. The re-opening and resealing operations are identical to the operations described above.

In the invention, if necessary all the layers may include sublayers. Thus, the support layer may comprise two PET layers, between which a layer of printing ink and a binder layer are placed. In addition, the complexable layer may include a layer, for example, of EVA having a high VA content and a PE layer (on the adhesive side); this additional layer may act as a reinforcing layer.

The following examples illustrate the invention without limiting it. The ratios and proportions are by weight.

### EXAMPLES

In these examples, the following components were used:

| | |
|---|---|
| PE1: | MDPE containing slip and antiblock additives (5% by weight); |
| PE2: | LDPE containing slip and antiblock additives (4% by weight); |
| L1: | binder based on EVA grafted with maleic anhydride |
| | (OREVAC ® from Atofina); |
| L2: | binder based on EVA (BYNEL ® 11E554 from DuPont); and |
| HM: | hot melt M3062 (from Ato Findley). |

### Examples 1 and 2 (Comparative Examples) and 3 and 4 (According to the Invention)

The following multilayers were produced:

| | | PE layer | Binder | | Binder | Layer |
|---|---|---|---|---|---|---|
| Ex. | | No. 1 | No. 1 | Adhesive | No. 2 | No. 2 |
| 1 | Composition | PE1 | L1 | HM | L1 | PE2 |
| | | | | (100%) | | |
| | Thickness (μm) | 16 | 4 | 20 | 4 | 16 |
| 2 | Composition | PE1 | L2 | HM | L2 | PE2 |
| | | | | (100%) | | |
| | Thickness (μm) | 16 | 4 | 20 | 4 | 16 |
| 3 | Composition | PE1 | L2 | HM/L2 | L2 | PE2 |
| | | | | (80/20) | | |
| | Thickness (μm) | 16 | 4 | 20 | 4 | 16 |
| 4 | Composition | PE1 | L2 | HM/L2 | L2 | PE2 |
| | | | | (80/20) | | |
| | Thickness (μm) | 15 | 5 | 10 | 5 | 15 |

The extrusion conditions on a tube extruder were the following:

PEI: 175-185° C.;

L1 or L2: 165-175° C.;

PE2: 165-175° C.;

adhesive: 135-145° C.

Head and die: 160-175° C.

The multilayers obtained were then complexed (the PEI layer is complexable—it was corona-treated) to a 400 μm PVC sheet using a two-component polyurethane adhesive with a solvent, having a thickness of about 3 μm. These final structures were thermoformed on a suitable device, under the following conditions:

preheat to 90-120° C.;

welding temperature: 160±5° C.;

welding time: 2±0.5 s;

welding pressure: 5±0.5 bar.

Once the trays have been welded, they were tested as regards the opening force and reseal strength (with a pull rate of 200 mm/min). The type of tearing in the adhesive was also characterized (in order to determine whether there was delamination or cohesive failure). The results are collated in the following table.

| | | | | Rebonding force | |
|---|---|---|---|---|---|
| | Opening force | | | (g/10 mm) | |
| | (g/10 mm) | | Type of | After 1 | After 3 |
| Ex. | Initiation | Propagation | tearing | rebonding | rebondings |
| 1 | 1600 | 1500 | Delamination | 0 | 0 |
| 2 | 1730 | 1280 | Delamination | 200-250 | 150 |
| 3 | 2260 | 1780 | Cohesive | 300-350 | 150-200 |
| 4 | 2800 | 1600 | Cohesive | 800-1600 | 400-600 |

In the case of examples 1 and 2, there was delamination, whereas in examples 3 and 4 according to the invention there was failure within the hot melt. In the latter case, the failure was characterized by the presence of the hot melt on both faces of the opening region. The latter was characterized by a tacky feel on both its faces.

### Example 1 (Comparative Example) and Examples 5 and 6 (According to the Invention)

The following multilayers were produced:

| | | PE layer | Binder | | Binder | Layer |
|---|---|---|---|---|---|---|
| Ex. | | No. 1 | No. 1 | Adhesive | No. 2 | No. 2 |
| 1 | Composition | PE1 | L1 | HM | L1 | PE2 |
| | | | | (100%) | | |
| | Thickness (μm) | 16 | 4 | 20 | 4 | 16 |
| 5 | Composition | PE1 | L1 | HM/L1 | L1 | PE2 |
| | | | | 80/20 | | |
| | Thickness (μm) | 16 | 4 | 20 | 4 | 16 |
| 6 | Composition | PE1 | L1/HM | HM | L1/HM | PE2 |
| | | | (80/20) | (100%) | (80/20) | |
| | Thickness (μm) | 16 | 4 | 20 | 4 | 16 |

The extrusion conditions were similar to those described in example 1.

The multilayers obtained were then complexed in the same way as in example 1.

Once the trays had been welded, they were tested under the same conditions as example 1. The results are collated in the table below.

| | | | | Rebonding force | |
|---|---|---|---|---|---|
| | Opening force | | | (g/10 mm) | |
| | (g/10 mm) | | Type of | After 1 | After 3 |
| Ex. | Initiation | Propagation | tearing | rebonding | rebondings |
| 1 | 1600 | 1500 | Delamination | 0 | 0 |
| 5 | 1710 | 1500 | Cohesive | 720 | 780-1120 |
| 6 | 1710 | 1400 | Cohesive | 950 | 300-1100 |

In the case of examples 5 and 6, there was failure within the hot melt, as previously in the case of examples 3 and 4. This is because, in these cases, the failure is characterized by the presence of the hot melt on both faces of the opening region. This is characterized by the tacky feel present on both its faces.

1-30. (canceled)

31. A multilayer structure comprising:
(a) a polyethylene layer;
(b) a binder layer;
(c) a layer of a hot melt/binder composition;
(d) a binder layer; and
(e) a layer of polymer;
it being possible for the binders of layers (b) and (d) and those contained in the compositions (c) to be identical or different; and
the hot melt/binder composition comprising at least one hot melt and at least one polymer binder, the hot melt comprising, in % by weight relative to the weight of the hot melt:
(i) 40 to 80% thermoplastic elastomer;
(ii) 20 to 60% tackifying resin;
(iii) up to 30% additives;
such that layer (a) is a rupturable layer.

32. A multilayer structure comprising:
(a) a polyethylene layer;
(b) a layer of a binder/hot melt composition;
(c) a hot melt layer;
(d) a layer of a binder/hot melt composition; and
(e) a layer of polymer;
it being possible for the hot melts of layers (b) and (d) and those contained in compositions (c) to be identical or different; and
the binder/hot melt composition comprising at least one hot melt and at least one polymer binder, the hot melt comprising, in % by weight relative to the weight of the hot melt:
(i) 40 to 80% thermoplastic elastomer;
(ii) 20 to 60% tackifying resin;
(iii) up to 30% additives;
such that layer (a) is a rupturable layer.

33. The structure as claimed in claim 31, in which the hot melt/binder composition comprises, by weight, 20 to 99% hot melt and 80 to 1% binder.

34. The structure as claimed in claim 33, in which the hot melt/binder composition comprises, by weight, 60 to 90% hot melt and 40 to 10% binder.

35. The structure as claimed in claim 32, in which the hot melt/binder composition comprises, by weight, 20 to 99% hot melt and 80 to 1% binder.

36. The structure as claimed in claim 35, in which the hot melt/binder composition comprises, by weight, 60 to 90% hot melt and 40 to 10% binder.

37. The structure as claimed in claim 31, in which the hot melt/binder composition comprises, by weight, 20 to 99% binder and 80 to 1% hot melt.

38. The structure as claimed in claim 37, in which the hot melt/binder composition comprises, by weight, 60 to 90% binder and 40 to 10% hot melt.

39. The structure as claimed in claim 32, in which the hot melt/binder composition comprises, by weight, 20 to 99% binder and 80 to 1% hot melt.

40. The structure as claimed in claim 39, in which the hot melt/binder composition comprises, by weight, 60 to 90% binder and 40 to 10% hot melt.

41. The structure as claimed in claim 31, in which, in the hot melt/binder composition, the binder is a binder based on an EVA resin, optionally grafted with maleic anhydride.

42. The structure as claimed in claim 32, in which, in the hot melt/binder composition, the binder is a binder based on an EVA resin, optionally grafted with maleic anhydride.

43. The structure as claimed in claim 31, in which, in the hot melt/binder composition, the binder is a binder based on metallocene PE.

44. The structure as claimed in claim 32, in which, in the hot melt/binder composition, the binder is a binder based on metallocene PE.

45. The structure as claimed in claim 31, in which the binder includes a tackifying agent.

46. The structure as claimed in claim 32, in which the binder includes a tackifying agent.

47. The structure as claimed in claim 31, in which the hot melt comprises at least one nonelastomeric polymer and at least one elastomeric polymer.

48. The structure as claimed in claim 32, in which the hot melt comprises at least one nonelastomeric polymer and at least one elastomeric polymer.

49. The structure as claimed in claim 47, in which the nonelastomeric polymer is chosen from EVA, PE, PP and EEA and/or the elastomeric polymer is chosen from thermoplastic elastomers or rubbers of the styrene block copolymer type, butadiene-based polymers and ethylene-propylene copolymers.

50. The structure as claimed in claim 48, in which the nonelastomeric polymer is chosen from EVA, PE, PP and EEA and/or the elastomeric polymer is chosen from thermoplastic elastomers or rubbers of the styrene block copolymer type, butadiene-based polymers and ethylene-propylene copolymers.

51. A method of preparing a structure as claimed in claim 31 by coextruding the various components of the layers.

52. A method of preparing a structure as claimed in claim 32 by coextruding the various components of the layers.

53. A resealable package comprising a structure as claimed in claim 31.

54. A resealable package comprising a structure as claimed in claim 32.

55. A resealable package comprising:
(A) a container, said container comprising a support layer, a structure as claimed in claim 31, this structure being attached to the support layer; and, facing it
(B) a cover, said cover comprising a second welding layer and a second support layer,
said welding layers being welded along a seam.

56. A resealable package comprising:
(A) a container, said container comprising a support layer, a structure as claimed in claim 32, this structure being attached to the support layer; and, facing it
(B) a cover, said cover comprising a second welding layer and a second support layer,
said welding layers being welded along a seam.

57. A resealable package comprising:
(A) a cover, said cover comprising a support layer, a structure as claimed in claim 31, this structure being attached to the support layer; and, facing it
(B) a container, said container comprising a second welding layer and a second support layer,
said welding layers being welded along a seam.

58. A resealable package comprising:
(A) a cover, said cover comprising a support layer, a structure as claimed in claim 32, this structure being attached to the support layer; and, facing it
(B) a container, said container comprising a second welding layer and a second support layer,
said welding layers being welded along a seam.

59. A resealable package comprising:
(A) a first film, said first film comprising a support layer, a structure as claimed in claim 31, this structure being attached to the support layer; and, facing it
(B) a second film, said second film being identical to the first film,
said welding layers being welded along a seam.

60. A resealable package comprising:
(A) a first film, said first film comprising a support layer, a structure as claimed in claim 32, this structure being attached to the support layer; and, facing it
(B) a second film, said second film being identical to the first film,
said welding layers being welded along a seam.
